(19) United States
(12) Patent Application Publication
(10) Pub. No.: US 2022/0247278 A1
(43) Pub. Date: Aug. 4, 2022

(54) ELECTRIC MACHINE PROVIDED WITH A TEMPERATURE SENSOR

(71) Applicant: NIDEC PSA EMOTORS, CARRIERES SOUS POISSY (FR)

(72) Inventors: Raphael SETBON, LEVALLOIS PERRET (FR); Stephane VONDENA, FEUCHEROLLES (FR)

(21) Appl. No.: 17/629,080

(22) PCT Filed: Jul. 9, 2020
(86) PCT No.: PCT/FR2020/051226

§ 371 Date: Jan. 21, 2022

(30) Foreign Application Priority Data
Jul. 22, 2019 (FR) 1908304

(51) Int. Cl. H02K 11/25; H02K 3/50

(52) U.S. Cl. CPC H02K 11/25; H02K 2203/09; H02K 3/50

(57) ABSTRACT

A rotating electric machine comprises a casing comprising a body and at least one closure flange attached to the body, the closure flange having an access opening and a removable flap for closing this opening, a temperature sensor, and a stator fixed in the body of the casing comprising a phase connector which comprises metal elements connected to conductors of the stator windings, these metal elements being held by an insulating support, the phase connector having tabs for connecting to a power supply bus, the connector being produced with a receiving zone for the temperature sensor which is arranged relative to the access opening such that the temperature sensor can be mounted on this receiving zone through the access opening of the closure flange.

### CROSS-REFERENCE TO RELATED APPLICATION

This application is the US National Stage under 35 USC § 371 of International Application No. PCT/FR2020/051226, filed Aug. 21, 2018 which claims the priority of French application 1908304 filed on Jun. 22, 2019, the content of (text, drawings and claims) being incorporated herein by reference.

### BACKGROUND

The present invention relates to rotating electric machines.

The invention relates more particularly to synchronous or asynchronous AC machines. It relates, in particular, to traction or propulsion machines for electric motor vehicles (battery electric vehicle) and/or hybrid motor vehicles (hybrid electric vehicle—plug-in hybrid electric vehicle), such as individual cars, vans, trucks or buses. The invention also applies to rotating electric machines for industrial and/or energy production applications, in particular naval, aeronautical or wind power applications.

It is known to provide rotating electric machines with a temperature sensor in order to detect any excessive temperature during operation of the machine.

Several techniques have been proposed for mounting this sensor in the past.

A widely used solution is to glue the sensor to the lead-out wire of a stator winding, this sensor being secured to a free cable which is then electrically connected to an electronic control circuit.

This solution has the drawback of making it difficult to replace the sensor in the event of failure, thus rendering the machine irreparable in most cases, which is very disadvantageous for a high-performance, high-cost machine.

In addition, the presence of a free cable attached to the sensor during the various stages of finishing and mounting the stator requires special care to be taken not to damage it and poses a problem for extensive automation of the machine's manufacturing process.

Other solutions have been proposed, such as snapping the sensor onto a copper conductor of the winding or mounting the sensor against the lead-out wire using a support fixed to the casing of the machine.

Moreover, the stator of some machines comprises a phase connector which is formed of metal elements, also known as “traces,” held by an insulating support, and the conductors of the windings are connected to these metal elements.

In the presence of such a connector, it has been proposed to glue the temperature sensor directly to one of these metal elements.

FR 3046505 discloses a machine in which the temperature sensor is held against a metal element of the phase connector by a cover which is folded against it. The cover can be formed integrally with the body of the connector and connected by a hinge thereto. Such a solution complicates the production of the phase connector and also requires having sufficient free space around the phase connector for the installation of the sensor which can make it difficult to produce a compact machine. However, it is desirable for the machine to be as compact as possible.

In addition, if the sensor is placed on the stator before mounting of the latter in the casing of the machine, the presence of the free cable connected to the sensor poses the problems risk of damage and difficulty in automation mentioned above.

FR 3037738 describes another solution in which the temperature sensor is carried by the phase connector. In this application, the temperature sensor comprises a housing carrying the sensing element which is held against a lead-out wire of the winding by a spring clip that connects the housing to the phase connector. The housing of the sensor is received in a specific cavity provided for this purpose on the stator, which complicates the production of the stator.

FR 2995739 discloses a solution in which the temperature sensor is not mounted on the phase connector but on a coil insulator.

### SUMMARY

There is therefore a need for a solution for mounting the temperature sensor which is compatible with extensive automation of the machine's manufacture and which allows easy replacement of the sensor in the event of failure thereof.

The above-noted needs are met, in part by the disclosed rotating electric machine and the method of manufacture. In accordance with one of its aspects, to the rotating electric machine comprises a casing comprising a body and at least one closure flange attached to the body, the closure flange having an access opening and a removable flap for closing this opening, a temperature sensor, and a stator fixed in the body of the casing comprising a phase connector which comprises metal elements connected to conductors of the stator windings, these metal elements being held by an insulating support, the phase connector having tabs for connecting to a power supply bus, the connector being produced with a receiving zone for the temperature sensor which is arranged relative to the access opening such that the temperature sensor can be mounted on this receiving zone through the access opening of the closure flange.

The disclosed rotating electric machine and method of manufacture allows the temperature sensor to be mounted while the stator is already in place in the casing of the machine. This means that the stator can be manufactured without the presence of the temperature sensor which avoids any risk of damage to the sensor and does not hinder the automation of the stator's manufacture.

In addition, the disclosed device and method of manufacture makes it possible, if desired, to make the temperature sensor easily removable by making it easily accessible. In particular, the sensor can be replaced without it being necessary to remove the stator from the casing of the machine.

The disclosed device and method also allow for a compact construction of the machine, and in particular of the stator, without the need to provide a specific location within the stator for receiving the sensor. The disclosed device and method makes it possible to take advantage of the free space in front of the insulating support of the phase connector, made necessary by the tabs for connecting to the power supply bus, in order to contain all or part of the sensor, in particular a housing for connecting to a cable that supplies the information generated by the sensor.

In the following, the closure flange of the casing body is referred to as the “front flange,” as opposed to the rear of the machine which is considered to be the side of the stator opposite the phase connector. Within the vehicle, however, the front flange can have any orientation relative to the direction of forward travel of the vehicle.

Preferably, one of the metal elements of the phase connector is produced with a mounting tab for the temperature sensor, preferably made of copper, like all the other elements. In this way, the conductor is heated by the heat generated by the operation of the machine and the current flowing through it which is representative of the electrical power. In addition, since this conductor is connected to one of the tabs for connecting to a phase of the power supply bus, it is easy to provide the mounting tab close to the connection tab, if this is desired.

Preferably, the temperature sensor comprises a sensing element bearing against the mounting tab. The temperature sensor can comprise a body made of insulating plastics material and a metal clamp which grips the mounting tab and presses the sensing element against one face of the mounting tab. In this way, good thermal contact can be obtained between the temperature sensing element, for example a NTC or PTC thermistor, or a thermocouple, and the mounting tab.

The mounting tab can have an opening, and the temperature sensor can have a hooking relief designed to engage in this opening when the sensor is mounted on the mounting tab. The hooking relief is formed with the elastic tab, for example. In this way, it is possible to secure the sensor by snapping it onto the mounting tab which is both solid and removable. Thus, preferably, the temperature sensor is removably mounted on said receiving zone of the phase connector.

Preferably, the mounting tab is oriented substantially in parallel with the axis of rotation of the motor. This allows the mounting of the housing of the sensor to be moved to the front, thus facilitating access to the sensor in case of replacement.

The receiving zone for the temperature sensor can be offset axially along the axis of rotation of the motor so that it is located at least partially in front of the tabs for connecting to the power supply bus. The mounting tab can have a free end which defines the forwardmost point of the phase connector.

The above-mentioned metal element, also referred to as a “trace” and comprising the mounting tab, also comprises one of the tabs for connecting to the power supply bus. This makes it easier to produce the mounting tab, since this can take place during the manufacture of the rest of the element, and the monolithic nature of the connection between the mounting tab and the rest of the element allows for good transmission of the heat associated with the passage of electric current through the element.

Preferably, the closure flange supports an electronics housing which houses an electronic circuit which is connected, e.g., to a position sensor of the rotor.

The temperature sensor can be electrically connected to this electronic circuit. The presence of the latter near the sensor makes it possible to limit the length of the cable connecting the sensor to the electronic circuit.

Preferably, the electronics housing comprises a connector for connecting an electrical plug present at the end of a cable of the temperature sensor. This can allow the sensor to be replaced without opening or removing the electronics housing. The disclosed device and method also relate to a method for manufacturing the machine as defined above, in which the temperature sensor is mounted on the phase connector while the stator is already in place in the casing provided with its closure flange.

### BRIEF DESCRIPTION OF THE DRAWINGS

The disclosed device and method will be better understood upon reading the following detailed description of a non-limiting embodiment thereof, and on examining the appended drawings, in which:

FIG. 1 partially and schematically shows an example of an electric machine according to the invention,

FIG. 2 shows the machine from FIG. 1 after removal of the closure flap,

FIG. 3 partially and schematically shows the phase connector and the electronics housing,

FIG. 4 shows, in isolation, a metal element of the phase connector provided with a mounting tab for the temperature sensor,

FIG. 5 is a view similar to FIG. 4, after mounting the temperature sensor, and

FIG. 6 shows the phase connector while waiting for the temperature sensor to be mounted, during the manufacture of the machine.

### DETAILED DESCRIPTION

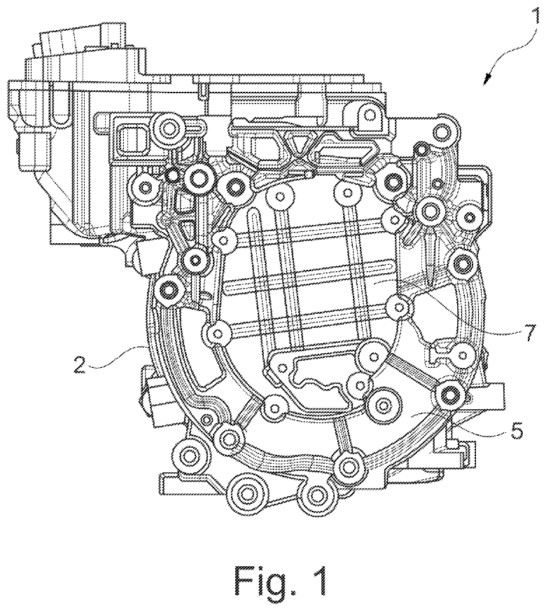

FIG. 1 shows an electric machine 1 which is intended to be mounted on a motor vehicle, for example, in order to serve as a traction or propulsion motor and, where appropriate, as a generator during the braking phases of the vehicle.

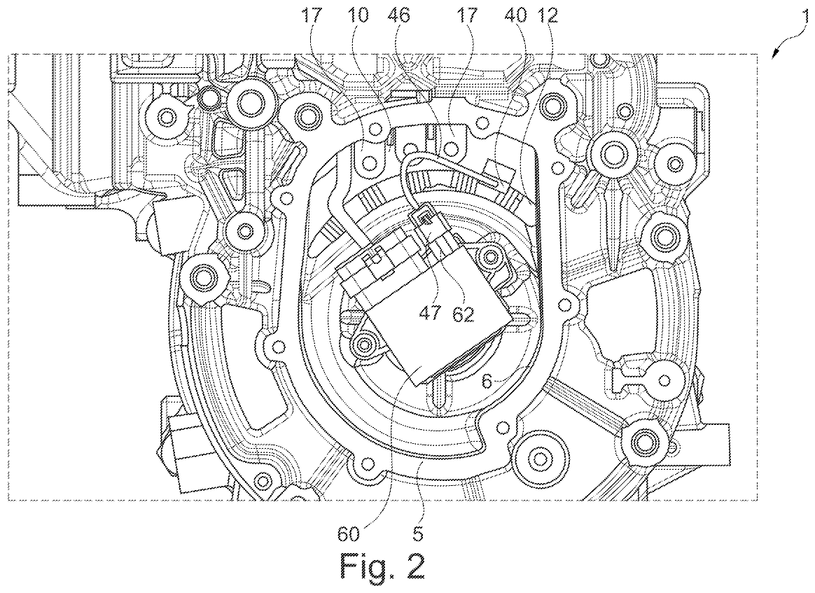

The machine 1 comprises a casing 2 which comprises a body closed at the front by a front flange 5 provided with an access opening 6, which can be seen in FIG. 2.

This opening 6 is normally closed by a removable flap 7, shown in FIG. 1.

The casing 2 houses a stator 10, which comprises a stack of magnetic sheets and phase windings.

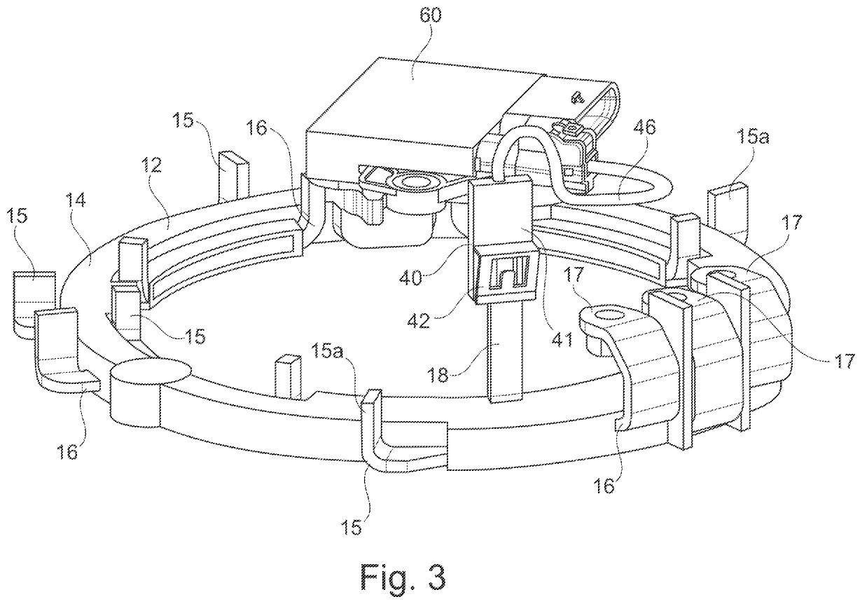

The conductors of the windings are electrically connected to a phase connector 12 which can be seen in particular in FIG. 3.

This connector 12 comprises metal elements 16 on which the conductors of the windings (not shown) are welded, as well as an insulating support 14 which holds these metal elements. The latter may include, as shown, tabs 15 which make it possible to weld the conductors. These tabs 15 have an angled portion defining an upright 15a which is oriented in parallel with the axis of rotation of the machine and on the back of which one or more conductors of the coils can be welded.

The connector 12 also comprises tabs 17 for connecting to a power supply bus (not shown).

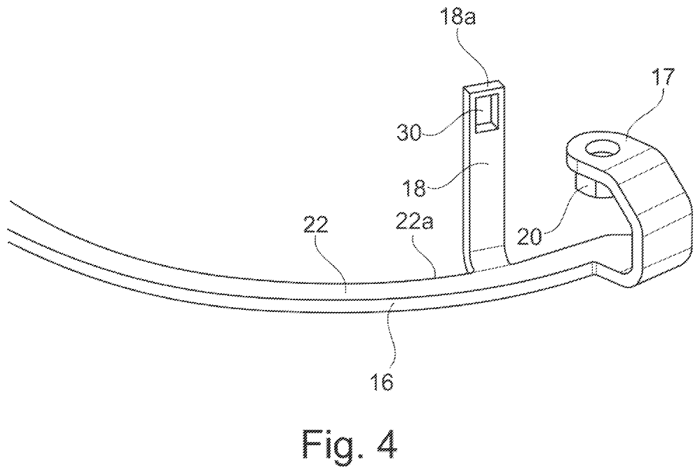

FIG. 4 shows one of the metal elements 16 which is provided with one of the tabs 17 for connecting to the phases of the power supply bus.

In the example at hand, this element 16 is produced with a mounting tab 18 which is directed toward the front in parallel with the axis of rotation.

This mounting tab 18 is preferably formed integrally with the connection tab 17 by cutting a copper strip, followed by bending and/or folding.

It can be seen in FIG. 4 that a nut 20 can be welded to the rear face of the connection tab 17 in order to receive a screw for tightening a terminal (not shown) connected to a power cable (not shown).

The mounting tab 18 extends perpendicularly to an arcuate portion 22 of the element 16, which is centered on the axis of rotation.

In the example shown, the mounting tab 18 is connected to the radially inner edge 22a of this portion 22, defining a right-angled bend at the junction therewith.

The insulating support 14 is for example overmolded onto the various metal elements 16 of the connector 12, but, in a variant, the insulating support is formed from one or more parts to which the elements 16 are otherwise attached, for example using a screw.

The mounting tab 18 comprises, near its free end, an opening 30 which is of rectangular shape in the example at hand and has a long side elongated along the longitudinal axis of the tab 18. The free end 18a of the mounting tab 18 can constitute the forwardmost point of the phase connector.

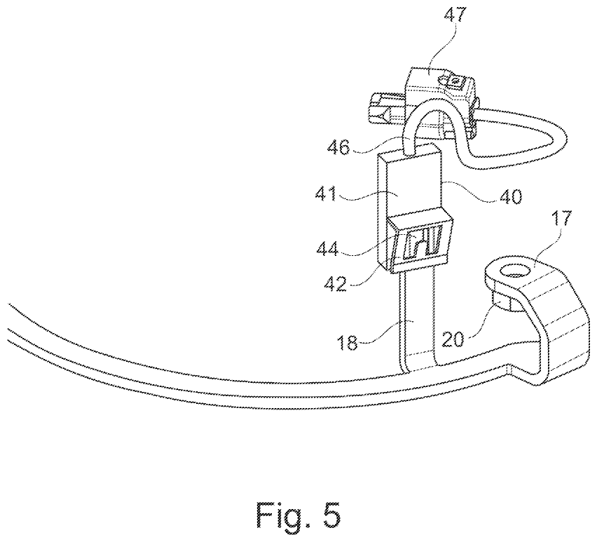

A temperature sensor 40 is mounted on the tab 18, as shown in FIG. 5.

This sensor 40 can include a plastic housing 41, and a metal clamp 42 attached to the housing 41.

The sensor 40 comprises a relief 44 arranged so as to snap into the opening 30, which ensures it is held on the tab 18.

The sensor 40 comprises a sensing element arranged so as to be pressed by the clamp 42 against the tab 18.

The sensor 40 comprises a cable 46 which comes out of the housing 41, as seen in FIG. 5, and is connected to an electric plug 47.

The machine 1 is connected to an inverter (not shown) which is electrically connected to the connection tabs 17 of the connector 12.

The machine 1 comprises an electronics housing 60 which is attached to the front flange 5, as shown in FIG. 2. This housing 60 houses an electronic circuit which can be used for dialog between the machine and the inverter, and which is connected in this example to a position sensor of the rotor as well as to the inverter.

The housing 60 is provided with a connector 62 which is used for connecting the plug 47 connected to the cable 46 of the temperature sensor 40. Thus, the electronic circuit in the housing 60 can transmit information about the position of the rotor as well as information about the temperature of the machine to the inverter.

As can be seen in FIG. 2, the connection tabs 17 and the mounting tab 18 are accessible through the opening 6 in the front flange 5 of the casing, in the absence of the flap 7. This allows easy replacement of the sensor 40 if necessary.

When manufacturing the machine 1, the stator can be manufactured without the temperature sensor 40, with the mounting tab 18 on standby, which reduces the risk of damaging the sensor 40 and avoids the presence of the corresponding cable 46.

The stator can be shrunk into the body of the casing.

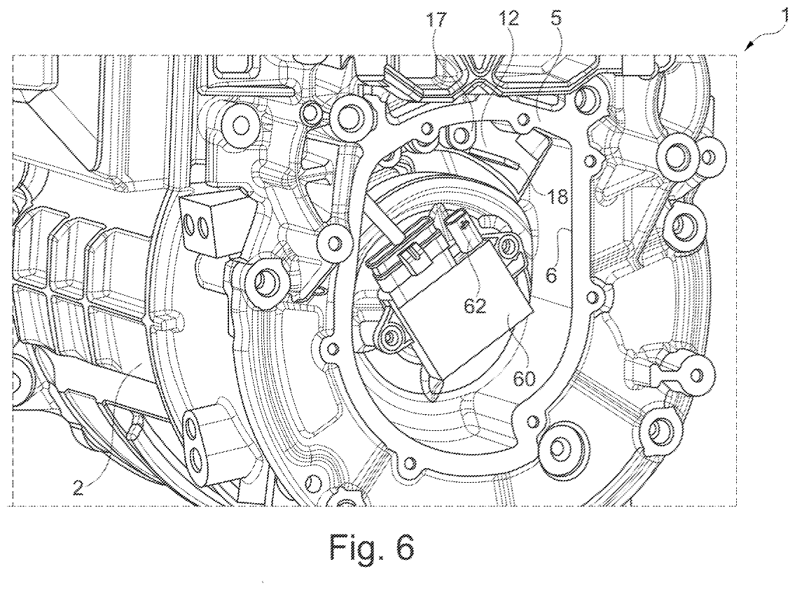

Once the front flange 5 of the casing is in place, together with the electronics housing 60, the mounting tab 18 remains accessible through the opening 6, as shown in FIG. 6, and the same goes for the tabs 17. The operator can then proceed to mount the temperature sensor 40 on the tab 18 by simply snapping the housing 41 with the clamp 42 onto the tab 18, and electrically connecting the plug 47 of the sensor 40 to the corresponding connector 62 of the housing 60.

Once the electrical connections have been established, the closure flap 7 can be attached to the front flange 5 in order to achieve the configuration shown in FIG. 1.

During the operation of the machine 1, the current flowing through the element 16 causes heating by the Joule effect, and the same applies in the stator windings.

The tab 18 is thus brought to a temperature representative of that of the hot spots of the machine 1, which makes it possible, e.g., to limit the power if a risk of exceeding the maximum admissible temperature is detected.

Of course, the disclosed device and method is not limited to the example which has just been described, and it is possible, e.g., to mount the temperature sensor 40 on the stator differently, for example by giving the insulating support 14 of the phase connector 12 a shape that allows the temperature sensor to be attached directly thereto.

1. A rotating electric machine comprising:
a casing comprising a body and at least one closure flange attached to the body, the closure flange having an access opening and a removable flap for closing the access opening, and a temperature sensor, and
a stator fixed in the body of the casing, comprising a phase connector which comprises metal elements connected to conductors of the stator windings, the metal elements being held by an insulating support, the phase connector having tabs for connecting to a power supply bus, the phase connector being produced with a receiving zone for the temperature sensor which is arranged relative to the access opening such that the temperature sensor can be mounted on this receiving zone through the access opening of the closure flange.

2. The machine according to claim 1, with one of the metal elements of the phase connector being produced with a mounting tab for the temperature sensor.

3. The machine according to claim 2, the temperature sensor comprising a sensing element bearing against the mounting tab.

4. The machine according to claim 3, the temperature sensor comprising a body made of insulating plastics material and a metal clamp which grips the mounting tab and presses the sensing element against one face of the mounting tab.

5. The machine according to claim 2, the mounting tab having an opening and the temperature sensor having a hooking relief designed to engage in this opening when the sensor is mounted on the mounting tab.

6. The machine according to claim 2, the mounting tab being oriented substantially in parallel with the axis of rotation of the machine.

7. The machine according to claim 2, wherein the metal element which comprises the mounting tab also comprises one of the tabs for connecting to the power supply bus.

8. The machine according to claim 1, wherein the closing flange supports an electronics housing.

9. The machine according to claim 8, wherein the temperature sensor is electrically connected to the electronics housing.

10. The machine according to claim 9, wherein the housing comprises a connector for connecting an electrical plug present at the end of a cable of the temperature sensor.

11. The machine according to claim 1, wherein the metal elements of the phase connector are made of copper.

12. The machine according to claim 1, wherein the receiving zone for the temperature sensor is offset axially along the axis of rotation of the machine so that it is located at least partially in front of the tabs for connecting to the power supply bus.

13. The machine according to claim 2, wherein the mounting tab has a free end which defines the forwardmost point of the phase connector.

14. The machine according to claim 2, wherein the temperature sensor is removably mounted on said receiving zone of the phase connector.

15. A method for manufacturing the machine as defined in claim 1, wherein the temperature sensor is mounted on the phase connector while the stator is already in place in the casing provided with its closure flange.
